(19) United States
(12) Patent Application Publication
(10) Pub. No.: US 2017/0124860 A1
(43) Pub. Date: May 4, 2017

(54) OPTICAL TRANSMITTER AND METHOD THEREOF

(71) Applicant: VIA TECHNOLOGIES, INC., New Taipei City (TW)

(72) Inventors: Terrance Shiyang SHIH, Milpitas, CA (US); Did-Min SHIH, New Taipei City (TW)

(21) Appl. No.: 14/932,196

(22) Filed: Nov. 4, 2015

(51) Int. Cl. G08C 23/04

(52) U.S. Cl. CPC G08C 23/04

(57) ABSTRACT

A method and an optical transmitter utilizing the same are provided. The method, adopted by an optical transmitter, transmitting data signal and control signal to an optical receiver of an target device, including: providing a data signal in a first frequency band; providing a control signal in a second frequency band; combining the data signal in the first frequency band and the control signal in the second frequency band to generate a combined signal; and converting the combined signal into an outgoing optical signal to be transmitted to the optical receiver; wherein the control signal is arranged for controlling the target device.

### BACKGROUND OF THE INVENTION

Field of the Invention

The present invention relates to a high-speed serial data link communication system, and in particular relates to a method of transmitting data and control signal over an optical cable and an optical transmitter utilizing the same.

Description of the Related Art

An active optical cable (AOC) is an optical fiber cable that is terminated on each end with a plug that contains an optical transceiver module that converts electrical signals into optical signals and optical signals into electrical signals.

Increasing number of communication networks now adopt AOCs to extend the transmission distance. However, the communication networks typically employ a number of control signals and data signals to operate connections and communications between network components. The control signals are typically transmitted via an additional copper wire or optical fiber, such that the cost for build communication network using AOCs has become considerable.

### BRIEF SUMMARY OF THE INVENTION

A detailed description is given in the following embodiments with reference to the accompanying drawings.

An embodiment of a method is disclosed, adopted by an optical transmitter, transmitting data signal and control signal to an optical receiver of a target device, including: providing a data signal in a first frequency band; providing a control signal in a second frequency band; combining the data signal in the first frequency band and the control signal in the second frequency band to generate a combined signal; and converting the combined signal into an outgoing optical signal to be transmitted to the optical receiver; wherein the control signal is arranged for controlling the target device.

Another embodiment of an optical transmitter is disclosed, transmitting data signal and control signal to an optical receiver of a target device, including: a control data converter, a combiner circuit and an electrical-to-optical device. The control data converter is configured to convert a control signal into continuous wave (CW) signals with different predetermined frequencies respectively according to different states of the control signal. The combiner circuit, coupled to the control data converter, is configured to combine a data signal variously transmitted in a first frequency band and the CW signals to generate a combined signal. The electrical-to-optical device, coupled to the combiner circuit, is configured to convert the combined signal into an outgoing optical signal to be transmitted to the optical receiver.

### BRIEF DESCRIPTION OF THE DRAWINGS

The present invention can be more fully understood by reading the subsequent detailed description and examples with references made to the accompanying drawings, wherein:

FIG. 1 is a block diagram of an optical communication system 1 according to an embodiment of the invention;

FIG. 2A is a schematic diagram for an optical transmission device 2 according to an embodiment of the invention;

FIG. 2B is a schematic diagram for an optical transmission device 2 according to another embodiment of the invention;

FIG. 3 is a block diagram of an optical receiver 3 according to an embodiment of the invention; and

FIG. 4 is a flowchart of an optical transmission method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Various aspects are described herein in connection with an optical communication system, which can be a Universal Serial Bus (USB) system, a Peripheral Component Interconnect Express (PCIe) system, a High-Definition Multimedia Interface (HDMI) system, a Display Port (DP) system, an Accelerated Graphics Port (AGP) system, or any communication system which adopts optical fibers as a transmission medium.

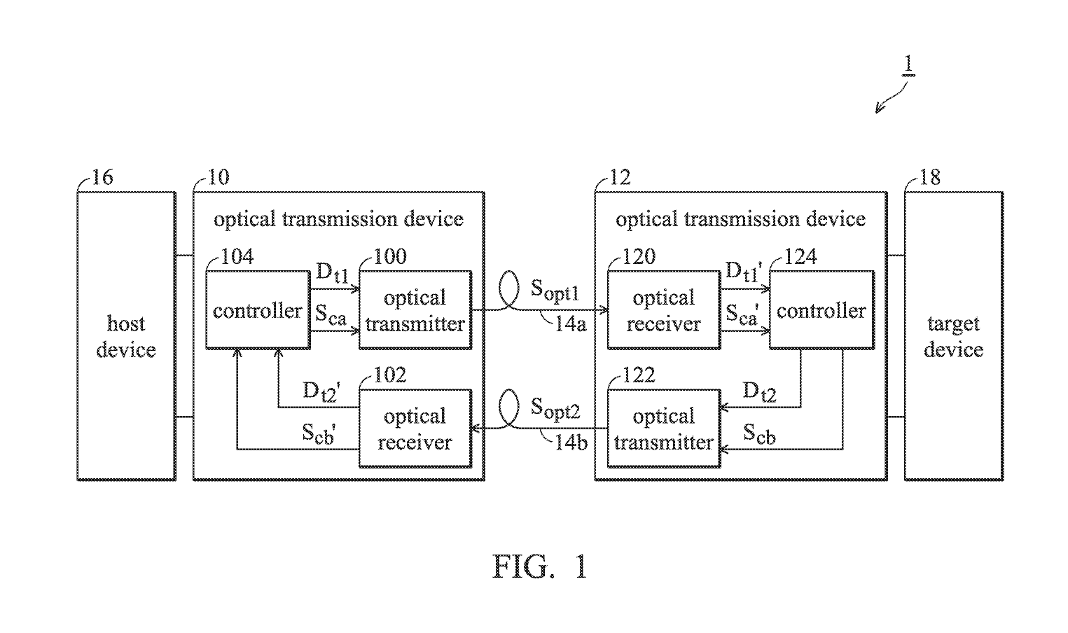

FIG. 1 is a block diagram of an optical communication system 1 according to an embodiment of the invention, including a host device 16, a target device 18, and two optical transmission devices 10 and 12, coupled thereto by optical cables 14a and 14b. The optical transmission device 10 is coupled to the host device 16. The optical transmission device 12 is coupled to the target device 18. The optical transmission devices 10 and 12 and the optical cables 14a and 14b are formed as an AOC (Active Optical Cable) for example. The host device 10 can be in communication with the target device 12 at a distance using the AOC cable to carry communication information. The host device 10 may be, but not limited to, an USB host device or a PCIe host device. The target device 12 may be, but not limited to, an USB device or a PCIe device. The optical cables 14a and 14b may be constructed in form of separate cables or a combined cable.

When the optical transmission devices 10, 12 and the optical cables 14a and 14b are formed an AOC (Active Optical Cable) for example, the plugs on the ends of the AOC have housings that are configured to be received within sockets on circuit boards of the host device 16 and the target device 18.

The host device 16 can send data information and control information in electrical form to the target device 12 via the two optical transmission device 10, 12 and the optical cable 14a coupled thereto. The target device 18 may send data information and control information in electrical form to the host device 16 via the two optical transmission device 10, 12 and the optical cable 14b coupled thereto. The control information from the host device 16 is used to regulate data transmission between the host device 16 and the target device 18, or manage the state of the target device 18. In one embodiment, the control information and the data information belong to the same communication protocol. The control information may include, but is not limited to, clock signals, reset signals, and power status signals. Preferably, the control information from the host device 16 may be the remote wake up signal for resuming the target device 18, or a state switch signal for switching the state of a state machine of the target device 18

The data information and control information are taken in form of electrical signals, which in turn are encoded and converted into an optical signal for optical transmission in the optical transmission device 10, 12. For example, the optical transmission device 10 may transmit an optical signal Sₒₚₜ₁ which contains the data information Dₜ₁ and the control information S_{ca} over the cable 14a to the optical transmission device 12, and the optical transmission device 12 may transmit an optical signal Sₒₚₜ₂ which contains the data information Dₜ₂ and the control information S_{cb} over the cable 14b to the optical transmission device 10.

In operation, the optical transmission device 10 and the optical transmission device 12 can exchange data in each transmission direction by transmitting a data signal in a first frequency band and a control signal in a second frequency band of the common optical signal Sₒₚₜ₁ or Sₒₚₜ₂ over the optical cable 14a or 14b. That is, the optical transmission device 10 may transmit data signal in a first frequency band and the control signal in a second frequency band to the optical transmission device 12 via the optical fiber 14a. Similarly, the optical transmission device 12 may transmit data signal in the first frequency band and the control signal in the second frequency band to the optical transmission device 10 via the optical fiber 14b. Furthermore, the protocol used to communicate the host device 16 and the target device 18 is, but is not limited to, USB 3.0 standard. In USB 3.0 system, a data burst may be transmitted at a rate of 5 Gbps, or in a frequency band between 500 MHz and 2.5 GHz after encoding in a normal mode, and communicates to each other via a Low Frequency Periodic Signaling (LFPS) at 10 to 50 MHz in an idle mode. As a result, the control signals may be sent in a frequency band other than the frequency bands between 500 MHz and 2.5 GHz and between 10 MHz to 50 MHz. For instance, the control signal may be, but not limited to, transmitted at any frequency below 10 MHz without causing interference to transmission of the data signal. Since the data information and the control information can be encapsulated and transmitted in one optical signal, it is no longer required to adopt separate copper wires or optical fibers for transferring the control information between the optical transmission device 10 and the optical transmission device 12, instead, a common optical cable can be utilized to perform the optical transmission. As a result, the implementation cost can be reduced.

The optical transmission device 10 contains an optical transmitter 100, an optical receiver 102, and a controller 104. The controller 104, coupled to the optical transmitter 100 and the optical receiver 102, is configured to control the data flow and operations of the optical transmitter 100 and the optical receiver 102. For a transmission path, the controller 104 receives the data information and the control information from the host device 16 and provides the data information and the control information in the form of the data Dₜ₁ and S_{ca} (i.e., data signal Dₜ₁ and control signal S_{ca}) respectively to the optical transmitter 100. The data Dₜ₁ may be variously transmitted in a first frequency band between 500 MHz and 2.5 GHz in a normal mode or 10 to 50 MHz in an idle mode. In turn, the control information is processed by the controller 104 to form the data S_{ca}, a CW (continuous wave) signal with a second frequency which is non-overlapping with the first frequency band. The optical transmitter 100 combines the data Dₜ₁ and S_{ca} to output a combined signal, and then converts the combined signal to the optical signal Sₒₚₜ₁ to be transmitted to the optical receiver 120 of the optical transmission device 12 over the optical cable 14a. For a reception path, the optical receiver 102 receives the optical signal Sₒₚₜ₂ from the optical transmission device 12, converts the optical signal Sₒₚₜ₂ back to an electrical signal, and separates and recovers the data information and the control information in the form of data Dₜ₂ and S_{cb} from the electrical signal. The controller 104 can acquire the recovered data Dₜ₂ and S_{cb} and operate according to the recovered data Dₜ₂ and S_{cb}.

Similarly, the optical transmission device 12 contains an optical receiver 120, an optical transmitter 122 and a controller 124. The controller 124, coupled to the optical receiver 120 and the optical transmitter 122, is configured to control the data flow and operations of the optical receiver 120 and the optical transmitter 122. For a reception path, the optical receiver 120 receives the optical signal Sₒₚₜ₁ on the optical cable 14a from the optical transmission device 10, converts the optical signal Sₒₚₜ₁ back to an electrical signal, and separates and recovers the data information and the control information in the form of data Dₜ₁ and S_{ca} from the electrical signal. The controller 124 then can acquire the recovered data Dₜ₁ and S_{ca} and operate according to the recovered data Dₜ₁ and S_{ca}. For a transmission path, the controller 124 receives the data information and the control information from the target device 18 and provides the data information and the control information in the form of the data Dₜ₂ and S_{cb} (i.e., data signal Dₜ₂ and control signal S_{cb}) to the optical transmitter 122. Similarly, the data Dₜ₂ may be transmitted in the first frequency band between 500 MHz and 2.5 GHz in a normal mode or 10 to 50 MHz in an idle mode. In turn, the control information is processed by the controller 124 to form the data S_{cb}, a CW (continuous wave) signal with the second frequency which is non-overlapping with the first frequency band, the optical transmitter 122 combines the data Dₜ₂ and S_{cb} to output a combined signal, and then converts the combined signal to the optical signal Sₒₚₜ₂ for transmission over the optical cable 14b to the optical transmission device 10.

The optical communication system 1 allows the optical transmission device 10 and optical transmission device 12 to transmit the data information and control information on non-overlapping frequency manner via the optical signal, That is to say, there is no need to build dedicated optical signal for transmitting the control information. In this way, the implementation cost of building the optical communication system 1 is reduced.

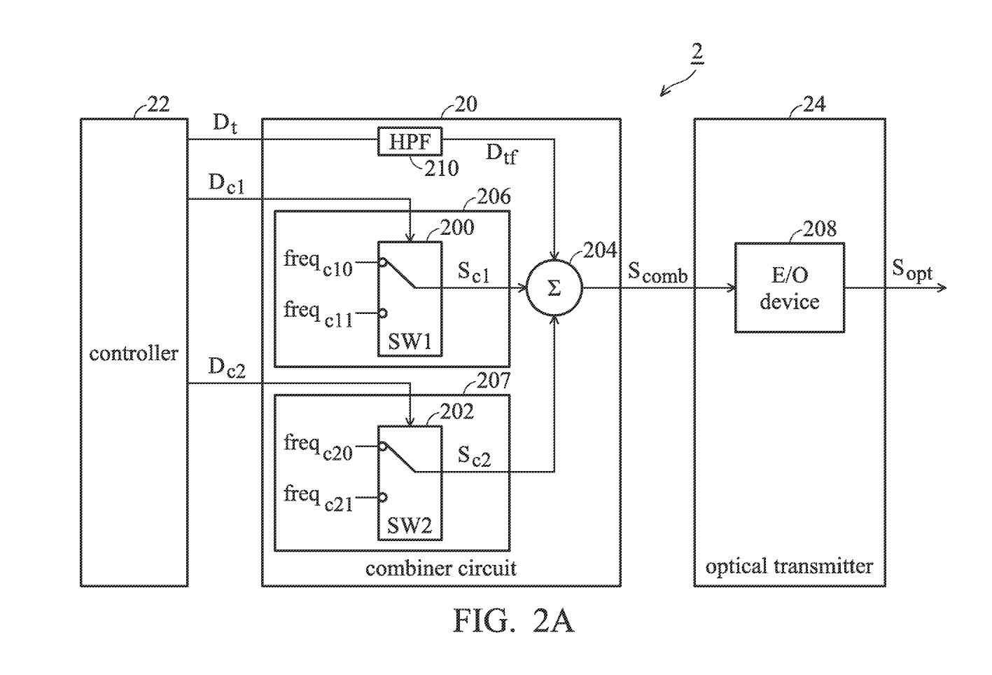

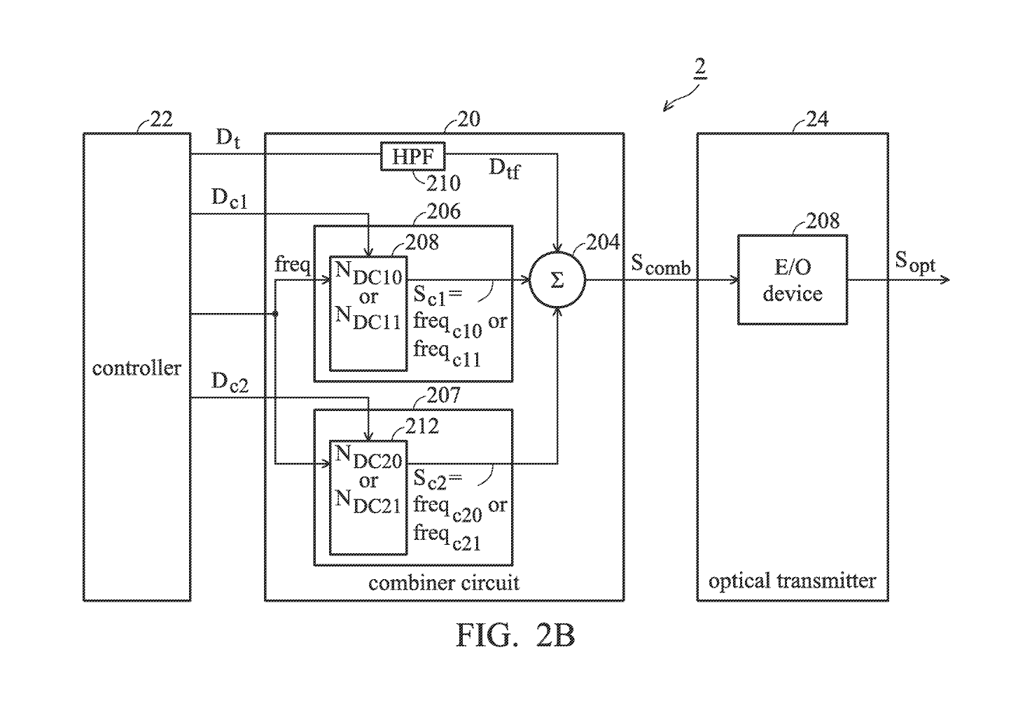

FIG. 2A is a schematic diagram of an optical transmission device 2 according to an embodiment of the invention. The optical transmission device 2 may serve as the optical transmission device 10 or optical transmission device 12 in FIG. 1.

The optical transmission device 2 contains the controller 22, a combiner circuit 20, and an optical transmitter 24. The combiner circuit 20 includes control data converters 206 and 207 and a combiner 204. The optical transmitter 24 includes an electrical-to-optical (E/O) device 208. In one embodiment, the combiner circuit 20 may be an independent circuit, or may be integrated into the controller 22. In one embodiment, the combiner 204 may be merged into the optical transmitter 24, while the two control data converters 206 and 207 are merged into the controller 22.

The data Dₜ is a high-speed data with a data frequency between 500 MHz and 2.5 GHz (in other word, a data is provided in a first frequency band). In one embodiment, the data is compliance with the USB 3.0 standard. In FIG. 2A, two control data converters 206 and 207 are configured to convert electrical control signals into two different CW signals with different frequencies, respectively. The frequencies of the two different CW signals are non-overlapping with the data frequency of the data Dₜ. In one embodiment, the control data converter converts a control signal into a CW signal with a predetermined frequency according to the state of the control signal. In one embodiment, the electrical control signal D_{c1} has two valid states. One state is “1” represented logic high, the other state is “0” represented logic low for example. The control data converter 206 converts the control signal D_{c1} into a CW signal with a first predetermined frequency if the control signal D_{c1} is logic high. Similarly, the control data converter 206 converts the control signal D_{c1} into another CW signal with a second predetermined frequency if the control signal D_{c1} is logic low. In an alternative embodiment, the first predetermined frequency may represent that the electrical control signal is in the one valid state, while the predetermined frequency absent may represent that the electrical control signal is in the other valid state. In addition, the first predetermined frequency and the second predetermined frequency are both lower than the frequency band of the data signal.

Please reference FIG. 2A, two switches 200 and 202 can be served as the control data converters described above. The control signals D_{c1} and D_{c2} serves as switch control signals SW1 and SW2, respectively, for controlling the switches 200 and 202, respectively. The frequencies freq_{c10}, freq_{c11}, freq_{c20}, and freq_{c21} are different from the data frequency of the data Dₜ, and may be in a low-frequency range, for example, less than 20 MHz, but not limited to. The four frequencies freq_{c10}, freq_{c11}, freq_{c20}, and freq_{c21} may be generated from a single source, or may be generated from different sources. Further, the frequencies freq_{c10}, freq_{c11}, freq_{c20}, and freq_{c21} are different to one another, and freq_{c10} and freq_{c11} represent two states of the control signal D_{c1} respectively, freq_{c20} and freq_{c21} represent two states of the control signal D_{c2} respectively. For example, the frequencies freq_{c10}, freq_{c11} may be 4 MHz and 5 MHz respectively. When the control signal D_{c1} is a first logic state, the switch 200 selects to output the frequency freq_{c10} as the electrical control signal S_{c1}, which is 4 MHz to the combiner 204. When the control signal D_{c1} is a second logic state, the switch 200 selects to output the frequency freq_{c11} as the electrical control signal S_{c1}, which is 5 MHz to the combiner 204. The switch 202 is operated in the same way. When the control signal D_{c2} is a first logic state, the switch 202 selects to output the frequency freq_{c20} as the electrical control signal S_{c2} to the combiner 204. When the control signal D_{c2} is a second logic state, the switch 202 selects to output the frequency freq_{c21} as the electrical control signal S_{c2} to the combiner 204. In addition, data Dₜ is filtered by a high-pass filter 210 to generate a filtered data signal D_{tf} prior to the combiner 204 to ensure the data Dₜ is more precisely. The switches 200 and 202 select frequencies freq_{c10}, freq_{c11}, freq_{c20}, and freq_{c21} by the control signals D_{c1} and D_{c2}, respectively to output the selected frequencies (electrical control signals S_{c1} and S_{c2}) to the combiner 204, which combine the selected frequencies and the filtered data signal D_{tf} to generate the combined signal S_{comb}. Because the frequencies freq_{c10}, freq_{c11}, freq_{c20}, and freq_{c21} and the frequency of the data Dₜ are non-overlapping to each other, they will not cause interference to one another in the combined signal S_{comb}.

The E/O device 208 contains a laser diode (not shown), or any other suitable laser device that could be substituted therefor. The laser diode generates an optical carrier signal with a predetermined carrier frequency and a wideband bandwidth. The E/O device 208 receives the combined signal S_{comb} from the combiner 204, modulates the combined signal S_{comb} with the optical carrier signal to output an optical signal Sₒₚₜ for communicating over the optical fibers (not shown). In one embodiment, the E/O device 208 simply receives the combined signal S_{comb} and transforms to an optical signal Sₒₚₜ for subsequent transmission in any manner.

Please reference FIG. 2B, which is a schematic diagram for an optical transmission device 2 according to another embodiment of the invention. The difference of FIG. 2A and FIG. 2B is that the control data converters are implemented by two programmable frequency dividers 208 and 212. Two programmable frequency dividers 208 and 212 both received the same frequency source freq. The control signals D_{c1} and D_{c2} serves as frequency divider control signals, respectively, for selecting corresponding frequency divider ratio according to the states of the control signals D_{c1} and D_{c2}, respectively. When the control signal D_{c1} is a first logic state, the frequency divider 208 selects a first predetermined frequency divider ratio N_{DC10} to output the frequency freq_{c10} as the electrical control signal S_{c1}, which is 4 MHz to the combiner 204. When the control signal D_{c1} is a second logic state, the frequency divider 208 selects a second predetermined frequency divider ratio N_{DC11} to output the frequency freq_{c11} as the electrical control signal S_{c1}, which is 5 MHz to the combiner 204. The frequency divider 212 is operated in the same way. When the control signal D_{c2} is a first logic state, the frequency divider 212 selects a third predetermined frequency divider ratio N_{DC20} to output the frequency freq_{c20} as the electrical control signal S_{c2} to the combiner 204. When the control signal D_{c2} is a second logic state, the frequency divider 212 selects a fourth predetermined frequency divider ratio N_{DC21} to output the frequency freq_{c21} as the electrical control signal S_{c2} to the combiner 204. The frequencies freq_{c10}, freq_{c11}, freq_{c20}, and freq_{c21} are different from the data frequency of the data Dₜ, and may be in a low-frequency range, for example, less than 20 MHz, but not limited to. In addition, data Dₜ is filtered by a high-pass filter 212 to generate a filtered data signal D_{tf} prior to the combiner 204 to ensure the data Dₜ is more precisely. The combiner 204 combines the output frequencies of the control data converters 206 and 207 and the filtered data signal D_{tf} to generate the combined signal S_{comb}. Because the frequencies freq_{c10}, freq_{c11}, freq_{c20}, and freq_{c21} and the frequency of the data Dₜ are non-overlapping to each other, they will not cause interference to one another in the combined signal S_{comb}. Although only two control signals D_{c1} and D_{c2} are shown in FIG. 2A and FIG. 2B, those skilled in the art would recognize that more control data may be converted and multiplexed into the optical signal Sₒₚₜ based on the same principle disclosed in the embodiment.

The optical transmission devices 10, 12 allow the host device 16 and target device 18 to transmit the data information and control information on non-overlapping frequencies via an optical signal, reducing the implementation cost of the optical cable.

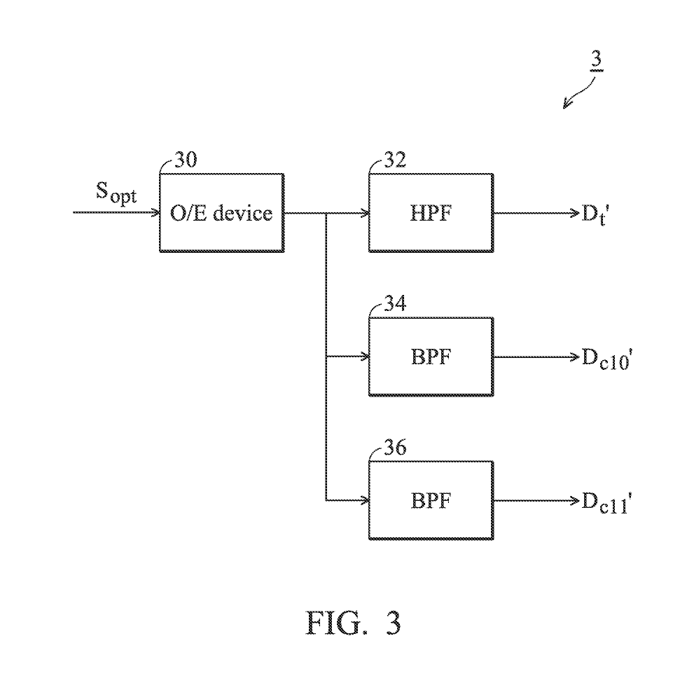

FIG. 3 is a block diagram of an optical receiver 3 according to an embodiment of the invention. The optical receiver 3 may be utilized to serve as the optical receivers 102 and 120 in FIG. 1. The optical receiver 3 receives an optical signal Sₒₚₜ for transmission over the optical cable and recovers electrical data and control signals from the optical signal Sₒₚₜ.

The optical receiver 3 contains an optical-to-electrical (O/E) device and filters 32, 34 and 36. The O/E device 30 contains a photodetector (not shown) and a transimpedance amplifier (TIA) (not shown). The photodetector detects the light wave of the optical signal Sₒₚₜ and the TIA transforms the detected optical signal Sₒₚₜ into a corresponding electrical signal.

The filter 32 is configured to filter out the electrical data signal Dₜ′. The filters 34 and 36 are configured for filtering out the frequencies freq_{c10}, and freq_{c11}, respectively. The filters 32, 34 and 36 may be band-pass filters which allow electrical data and control signals to be separated from the transformed electrical signal. The operating frequency ranges of the filters 32, 34 and 36 may be predetermined in compliance with the frequency spectrum design set out in the optical transmission device. Alternatively, the optical receiver 3 may also include a frequency detection circuit (not shown) to actively detect all available frequency components in the optical signal Sₒₚₜ, and configure the operating frequency ranges for the filters 32, 34 and 36 accordingly. For example, the filter 32 may be configured to isolate the signal in the frequency band between 500 MHz-2.5 GHz, the filter 34 may be configured to isolate the signal in the frequency band centered at 4 MHz, and the filter 36 may be configured to isolate the signal in the frequency band centered at 5 MHz. In another embodiment, a band-pass filter (not shown in FIG. 3) can be added prior to the filters 34 and 36 to filter out a lower frequency range, for example, below 20 MHz. In addition, since the filter 32 is configured to separate the electrical data signal Dₜ′ occupying a highest frequency spectrum, the filter 32 may also be a high pass filter. The corresponding filters that filter out the frequencies freq_{c20}, and freq_{c21} are not shown in FIG. 3.

The optical receiver 3 allows the host device and target device to identify the data information and control information from an optical signal, reducing the implementation cost of the optical cable.

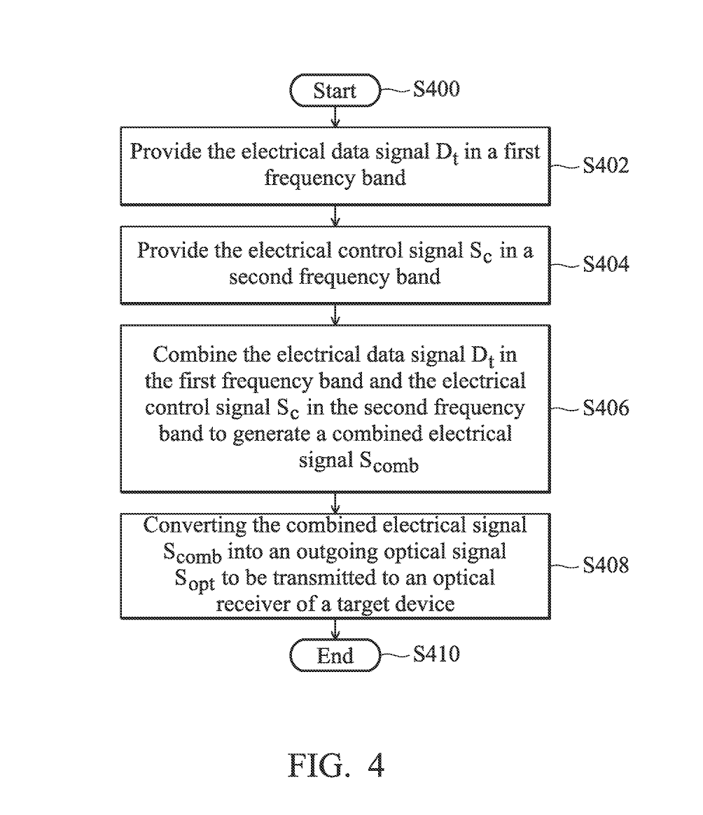

FIG. 4 is a flowchart of an optical transmission method according to an embodiment of the invention, incorporating the optical communication system 1 in FIG. 1 and the optical transmission device 2 in FIGS. 2A and 2B. The optical transmission method is initiated when the host device 16 or the target device 18 intends to transmit both the data signal and control signal over an AOC cable.

Upon startup of the optical transmission method, the host device 16 is in connection with the target device 18 via the AOC cable, ready to send the data and control information over the optical cable 14a (S400).

Next, the electrical data signal Dₜ in a first frequency band (S402) is provided. In one embodiment, the optical transceiver 100 is configured to transmit the electrical data signal Dt in a first frequency band. The first frequency band may have a range between 500 MHz and 2.5 GHz. Alternatively, data Dₜ is pre-filtered by a high-pass filter 210 to generate a filtered data signal D_{tf} to ensure the data Dₜ is more precisely.

Meanwhile, the electrical control signal S_{c} in a second frequency band is provided (S404). The second frequency band is non-overlapping with the first frequency band, and may have a range between 0 Hz and 10 MHz for example. The electrical control signal D_{c} and data signal Dₜ belong to the same communication protocol.

In some embodiments, the optical transceiver 100 is configured to transmit the electrical control signal D_{c} and convert the electrical control signal D_{c} to the electrical control signal S_{c} in a second frequency band according to the state of the electrical control signal D_{c}. Control data converter is implemented in the optical transceiver 100 and configured to convert electrical control signal D_{c} to the electrical control signal S_{c} in a second frequency band according to the state of the electrical control signal D_{c}. In one embodiment, the control data converter converts a control signal into a CW signal with a predetermined frequency according to the state of the control signal. In one embodiment, the electrical control signal D_{c} has two valid states. One state is “1” represented logic high, the other state is “0” represented logic low for example. The control data converter converts the control signal D_{c} into a CW signal with a first predetermined frequency if the control signal D_{c} is logic high. Similarly, the control data converter converts the control signal D_{c} into another CW signal with a second predetermined frequency if the control signal D_{c} is logic low. In an alternative embodiment, the first predetermined frequency may represent that the electrical control signal is in the one valid state, while the predetermined frequency absent may represent that the electrical control signal is in the other valid state. In addition, the first predetermined frequency and the second predetermined frequency are both lower than the frequency band of the data signal.

In other embodiments, the optical transceiver 100 converts the electrical control signal D_{c} to just one electrical control signal S_{c}, which represents a predetermined state of the electrical control signal D_{c}. That is, the optical receiver 120 automatically interprets the electrical control signal D_{c}, as the state other than the predetermined state when the electrical control signal S_{c} is not received, and considers the electrical control signal D_{c} as the predetermined state when the electrical control signal S_{c} is received.

The combiner circuit 206 then combines the data signal Dₜ or the filtered data signal D_{tf} in the first frequency band and the electrical control signal S_{c} in the second frequency band to generate a combined electrical signal S_{comb} (S406). Because the data signal and the electrical control signal adopt non-overlapping frequency bands, they will not cause interference to one another in the combined signal S_{comb}.

Lastly, the E/O device 208 is configured to convert the combined signal S_{comb} into an outgoing optical signal Sₒₚₜ (S408) and transmit the outgoing optical signal Sₒₚₜ over the optical cable to the target device 12. Because both the data and control signals can be carried on the same optical signal Sₒₚₜ without causing interference to each other, only one optical cable is needed for the transmission. As a consequence, the implementation cost for building an optical communication network is reduced.

Although the embodiment explained in the preceding paragraphs employs the host device 16 to illustrate each step in the optical transmission method, it should be recognized that the target device 18 can also adopt the optical transmission method for initiating a transmission from the target device 18 to the host device 16.

The optical transmission method allows the host device and target device to transmit the data information and control information on non-overlapping frequency bands via an optical signal, reducing the implementation cost of building the optical communication system 1.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, processor, microprocessor or state machine.

The operations and functions of the various logical blocks, modules, and circuits described herein may be implemented in circuit hardware or embedded software codes that can be accessed and executed by a processor.

While the invention has been described by way of example and in terms of the embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method, adopted by an optical transmitter, transmitting data signal and control signal to an optical receiver of a target device, comprising:
providing a data signal in a first frequency band;
providing a control signal in a second frequency band;
combining the data signal in the first frequency band and the control signal in the second frequency band to generate a combined signal; and
converting the combined signal into an outgoing optical signal to be transmitted to the optical receiver;
wherein the control signal is arranged for controlling the target device.

2. The method of claim 1, wherein the control signal has two valid states, and a first predetermined frequency present in the second frequency band represents one valid state of the control signal, and a second predetermined frequency present in the second frequency band represents the other valid state of the control signal.

3. The method of claim 1, wherein the control signal has two valid states, and a predetermined frequency present in the second frequency band represents the control signal is in the one valid state, while the predetermined frequency absent from the second frequency band represents the control signal is in the other valid state.

4. The method of claim 1, wherein the second frequency band covers a frequency range lower than that of the first frequency band.

5. The method of claim 1, wherein the step of providing the control signal in the second frequency band comprises:
converting the control signal into continuous wave (CW) signals with different predetermined frequencies respectively according to different states of the control signal.

6. The method of claim 1, wherein the step of providing the control signal in the second frequency band comprises:
selecting a corresponding frequency in the second frequency band according to a state of the control signal.

7. The method of claim 1, wherein the second frequency band is non-overlapping with the first frequency band.

8. An optical transmitter, transmitting data signal and control signal to an optical receiver of a target device, comprising:
a control data converter, configured to convert a control signal into continuous wave (CW) signals with different predetermined frequencies respectively according to different states of the control signal;
a combiner circuit, coupled to the control data converter, configured to combine a data signal variously transmitted in a first frequency band and the CW signals to generate a combined signal; and
an electrical-to-optical device, coupled to the combiner circuit, configured to convert the combined signal into an outgoing optical signal to be transmitted to the optical receiver.

9. The optical transmitter of claim 8, wherein the control signal has two valid states, when the control signal is in a first state, the control data converter converts the control signal into a CW signal with a first predetermined frequency, and when the control signal is in a second state, the control data converter converts the control signal into a CW signal with a second predetermined frequency.

10. The optical transmitter of claim 8, wherein the control signal has two valid states, when the control signal is in a first state, the control data converter converts the control signal into a CW signal with a first predetermined frequency, and when the control signal is in a second state, the control data converter converts the control signal into a CW signal with a second predetermined frequency, and a predetermined frequency present in the second frequency band represents that the control signal is in the one valid state, while the predetermined frequency absent from the second frequency band represents that the control signal is in the other valid state.

11. The optical transmitter of claim 8, wherein the second frequency band covers a frequency range lower than that of the first frequency band.

12. The optical transmitter of claim 8, wherein:
the control data converter is configured to convert the control signal into the continuous wave (CW) signals with the different predetermined frequencies respectively according to different states of the control signal.

13. The optical transmitter of claim 8, wherein:
the control data converter is configured as a switch, for selecting a frequency in the second frequency band according to a state of the control signal.

14. The optical transmitter of claim 8, wherein:
the control data converter is configured as a programmable frequency divider coupled to a frequency source, and the control data converter selects a frequency divider ratio to output a divided frequency in the second frequency band according to a state of the control signal.

15. The optical transmitter of claim 8, wherein:
the control signal is arranged for controlling the target device to transport data and control data belong to a same protocol.
